(19) United States
(12) Patent Application Publication
(10) Pub. No.: US 2002/0009920 A1
(43) Pub. Date: Jan. 24, 2002

(54) Electrical household appliance with detachable connection cord

(76) Inventors: Willem Sjouke Wijma, Drachten (NL); Fokke Roelof Voorhorst, Drachten (NL)

Correspondence Address: Jack E. Haken, Philips Electronics North America Corp., 580 White Plains Road, Tarrytown, NY, 10591, US

(21) Appl. No.: 09/862,288

(22) Filed: May 22, 2001

(30) Foreign Application Priority Data
May 25, 2000 (EP) 00201877.8

(51) Int. Cl. H01R 11/00

(52) U.S. Cl. 439/502

(57) ABSTRACT

A combination of an electrical household appliance (1) and an electrical connecting cord (2). A wall (3) of the housing is provided with a cavity (4) in which connection terminals (5) are arranged. The electrical connection cord comprises a plug (13) with connection terminals (14). To connect the appliance to the mains, for example to recharge batteries in the appliance, the plug (13) of the cord is inserted into the cavity (4) of the housing wall, whereby the connection terminals (5,14) make contact. The appliance comprises a lamp (11) to indicate that the appliance is connected to the mains. The light of the lamp is radiated into the cavity (4). The plug (13) is made of a translucent material. The light of the lamp is radiated towards the plug so that the whole plug is clearly visible, indicating the status of the appliance.

The invention relates to a combination of an electrical household appliance and an electrical connection cord which can be detachably connected to the appliance, said appliance having a housing wall which is provided with a cavity in which electrical connection contacts of the appliance are present, said electrical connection cord having a connection plug which is also provided with electrical connection contacts and which can be inserted into the cavity of the housing wall of the appliance such that a portion of the plug projects to outside the cavity, while the electrical connection contacts are connected to one another, said appliance being further provided with an indicator lamp.

Such a combination of an appliance and a connection cord is generally known and is widely used, for example, for rechargeable appliances such as electric shavers. When the appliance is to be charged, the plug of the connection cord is connected to the appliance and the mains plug of the connection cord is inserted into the mains outlet. To indicate that the appliance is under tension, a lamp on the appliance starts to burn, which is usually visible through an opening in the housing wall. The lamp at the same time serves to signal the instantaneous state of a process, for example the recharging process. This may be further visualized by means of flickering lamps and/or lamps of various colors. Such lamps, however, can only be observed from a comparatively narrow viewing angle.

It is an object of the invention to improve the visual status signaling of an electrical household appliance with connection cord.

The invention is for this purpose characterized in that the housing wall is provided with an opening at the area of the cavity, in which opening the indicator lamp is present, and the plug is at least partly made of a translucent material. When the electrical connection cord with the connection plug is inserted into the cavity of the appliance and is connected to the mains, the indicator lamp will start burning. The light is coupled into the translucent material of the plug, so that the latter lights up. A light-emitting plug, i.e. that portion of the plug which projects from the housing wall, can be observed from a much wider viewing angle than the small indicator lamps usual in such appliances.

The entire plug may be made from translucent material. Preferably, however, the plug consists of two parts, i.e. a first part of transparent material which forms the end of the plug and a second part of translucent material which merges into the first part. The part of transparent material serves as an optical waveguide towards the part of translucent material, so that a greater effective light output is obtained in the part of translucent material.

Preferably, the housing wall is provided with an opening at the area of the cavity, in which opening the indicator lamp is present. It is alternatively possible, however, to cover the opening mentioned above with a window behind which the indicator lamp is present. This is important especially if the appliance has to be watertight. If the location for incorporating an indicator lamp close to a cavity in the appliance presents a problem, an optical waveguide may be mounted by means of which light from the indicator lamp is coupled into the cavity. This leads to a higher freedom of design.

In a yet further embodiment, the plug is provided with a recess for the indicator lamp. The light is satisfactorily coupled into the translucent material of the plug as a result of this.

The invention also relates to an electrical household appliance and an electrical connection cord having the characteristics mentioned above.

The invention will now be explained in more detail below with reference to a few embodiments shown in a drawing, in which:

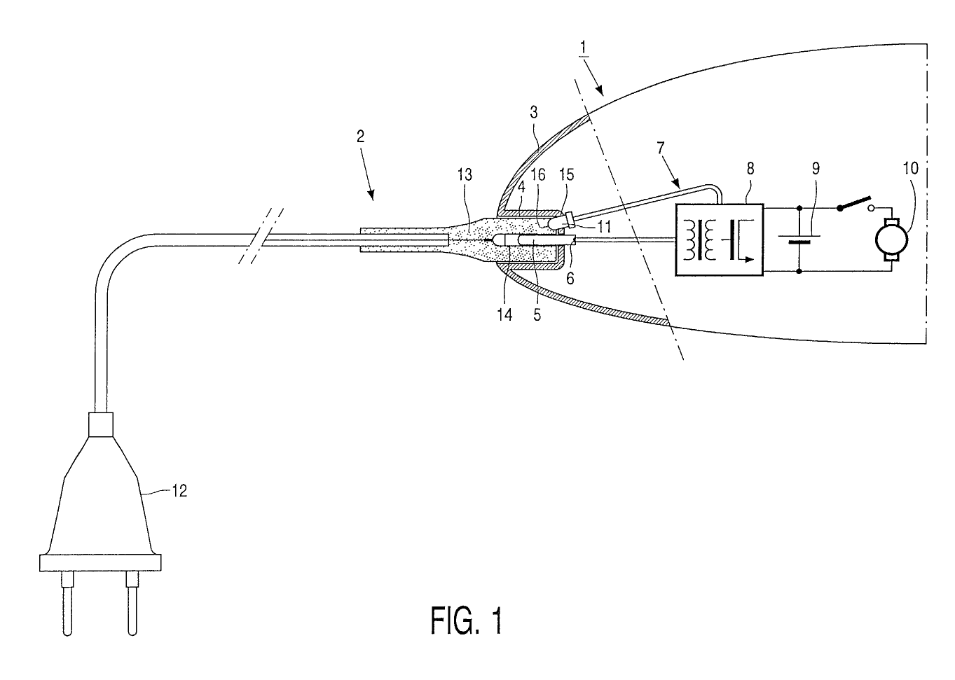

FIG. 1 is a partial cross-sectional view of a housing of an electric shaver with a connection cord in a first embodiment,

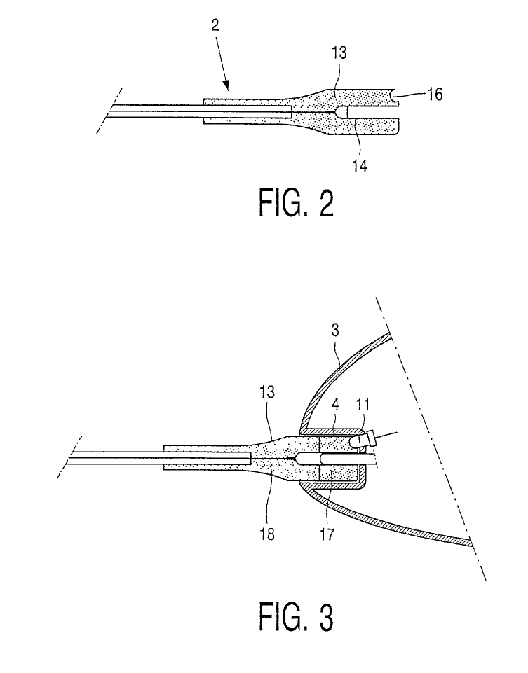

FIG. 2 shows the plug of the connection cord of FIG. 1,

FIG. 3 is a partial cross-sectional view of a housing of an electric shaver with a connection cord in a second embodiment,

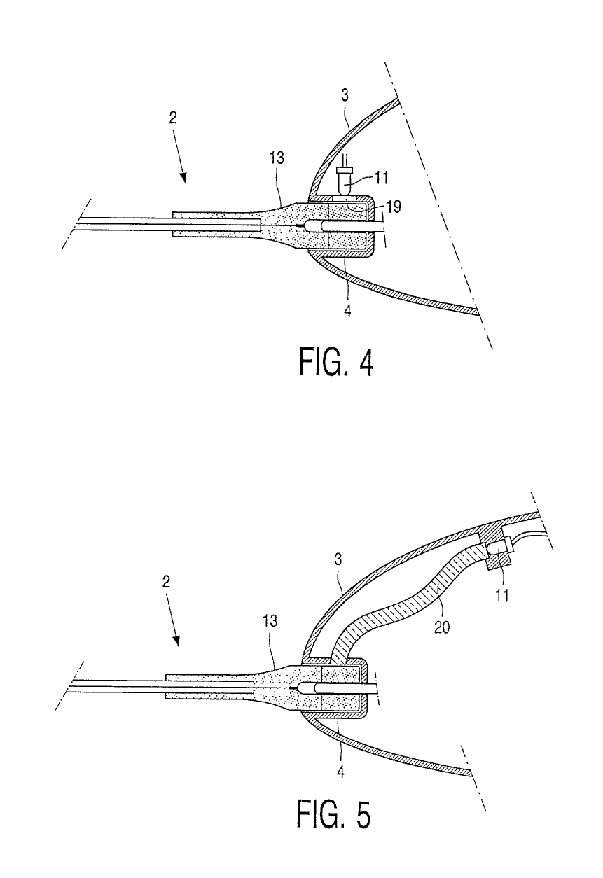

FIG. 4 is a partial cross-sectional view of a housing of an electric shaver with a connection cord in a third embodiment and

FIG. 5 is a partial cross-sectional view of a housing of an electric shaver with a connection cord in a fourth embodiment.

The combination of FIG. 1 is formed by an electric shaver 1 and an electrical connection cord 2. The shaver 1 has a housing wall 3 in which a cavity 4 is present. Electrical connection pins 5 (only one connection pin is visible in the Figure) are present in the cavity. One side 6 of each connection pin 5 is connected to an electrical circuit 7. This electrical circuit comprises, for example, a charging unit 8, a rechargeable battery 9, a motor 10, and an indicator lamp 11. The electrical connection cord 2 has a mains plug 12 at one side for connection to the mains, and an appliance plug 13 at the other side. This latter plug is provided with electrical connection bushes 14. To connect the connection cord 2 to the appliance 1, for example for charging the battery 9, the plug 13 is inserted into the cavity 4 of the housing wall 3. The connection bushes 14 of the plug 13 are passed over the connection pins 5 inside the cavity 4 thereby, so that an electrical connection is achieved. According to the invention, the indicator lamp 11 is arranged in an opening 15 of the housing wall 3 at the area of the cavity 4 such that, when the lamp is burning, the light shines into the cavity. According to the invention, furthermore, the plug 13 is made from a translucent material. In the example of FIG. 1, the entire plug is made of translucent material. The light of the lamp is coupled into the translucent material of the plug, so that the plug lights up and the user can clearly perceive that the battery 9 of the appliance is being charged. A material used as the translucent material may be, for example, a thermoplastic elastomer.

The plug may be further provided with a recess 16 for the indicator lamp 11 (see also FIG. 2). The indicator lamp projects somewhat from the housing wall 3 into the cavity 4, thus lying partly in the recess 16.

The example of FIG. 3 differs from that of FIG. 1 in that the plug 13 now consists of two parts, a first or front part 17 of transparent material, in which the major portions of the electrical connection bushes 14 are fastened, and a second part 18 which merges into the first part 17 and is made from a translucent material. The first part 17 in fact serves as a kind of optical waveguide for coupling the light into the translucent material of the second part 18. The material used for the first part 17 may be, for example, polycarbonate, while a suitable material for the second part 18 is a soft polyvinyl chloride.

In the embodiment shown in FIG. 4, the opening 15 in the housing wall 3 has a window 19 at the area of the cavity 4. The indicator lamp 11 is present in the appliance behind the window. The cavity may be made watertight in this manner, which is necessary for some appliances.

Finally, FIG. 5 shows an embodiment in which the indicator lamp is arranged at some distance from the cavity 4. This may be necessary in some cases for constructional reasons. An optical waveguide 20 is provided between the indicator lamp 11 and the cavity 4 so as to be able to couple light into the cavity nevertheless.

1. A combination of an electrical household appliance and an electrical connection cord which can be detachably connected to the appliance, said appliance having a housing wall which is provided with a cavity in which electrical connection contacts of the appliance are present, said electrical connection cord having a connection plug which is also provided with electrical connection contacts and which can be inserted into the cavity of the housing wall of the appliance such that a portion of the plug projects to outside the cavity, while the electrical connection contacts are connected to one another, said appliance being further provided with an indicator lamp, characterized in that the housing wall is provided with an opening at the area of the cavity, in which opening the indicator lamp is present, and the plug is at least partly made of a translucent material.

2. A combination of an electrical household appliance and an electrical connection cord as claimed in claim 1, characterized in that the entire plug is made of transparent material.

3. A combination of an electrical household appliance and an electrical connection cord as claimed in claim 1, characterized in that the plug consists of two parts, a first part of transparent material forming the end of the plug and a second part of translucent material merging into the first part.

4. A combination of an electrical household appliance and an electrical connection cord as claimed in claim 1, characterized in that the housing wall is provided with an opening at the area of the cavity, in which opening the indicator lamp is present.

5. A combination of an electrical household appliance and an electrical connection cord as claimed in claim 1, characterized in that the housing wall is provided with an opening at the area of the cavity, which opening is covered by a window and behind which opening the indicator lamp is present.

6. A combination of an electrical household appliance and an electrical connection cord as claimed in claim 1, characterized in that the appliance is provided with an optical waveguide by means of which the light of the indicator lamp is coupled into the cavity.

7. A combination of an electrical household appliance and an electrical connection cord as claimed in any one of the preceding claims, characterized in that the plug is provided with a recess for the indicator lamp.

8. An electrical connection cord suitable for connection to an electrical household appliance as claimed in any one of the preceding claims.

9. An electrical household appliance to which an electrical connection cord as claimed in any one of the claims 1 to 7 can be connected.
